(19) United States
(12) Patent Application Publication
(10) Pub. No.: US 2017/0114966 A1
(43) Pub. Date: Apr. 27, 2017

(54) PORTABLE LIGHT ASSEMBLY

(71) Applicant: Ronald McCurdy, Magnolia, TX (US)

(72) Inventor: Ronald McCurdy, Magnolia, TX (US)

(21) Appl. No.: 15/397,017

(22) Filed: Jan. 3, 2017

Related U.S. Application Data
(63) Continuation-in-part of application No. 15/331,618, filed on Oct. 21, 2016.
(60) Provisional application No. 62/244,597, filed on Oct. 21, 2015.

(51) Int. Cl. F21L 14/00; B60D 1/64; B60R 16/02; F21V 21/22; F21V 23/06

(52) U.S. Cl. CPC F21L 14/00; F21V 21/22; F21V 23/06; B60R 16/02; B60D 1/64; F21W 2131/10

(57) ABSTRACT

The present invention provides a portable lighting assembly for attachment to a vehicle for the illumination of a defined area. The assembly includes a mount configured to couple to the hitch of a vehicle. Additionally, a lighting unit is configured to illuminate the defined area. An extension device is in communication with the mount and configured to elevate and orient the lighting unit. A power element is configured to supply the lighting unit with electrical energy. The portable lighting assembly is coupled directly to a vehicle.

### CLAIM OF PRIORITY

This application claims the benefit of and is a Continuation in Part of U.S. application No. 15/331,618 filed Oct. 21, 2016, which claims the benefit of U.S. Provisional Application No. 62/4244,597 filed Oct. 21, 2015. The information contained therein is hereby incorporated by reference.

### BACKGROUND

1. Field of the Invention

The present application relates generally to lighting assemblies, and in particular to a portable light assembly carried by a vehicle.

2. Description of Related Art

Various types of industrial and commercial activities occur at night. A large number of these activities occur where there is no permanent fixed lighting devices. It becomes necessary to bring in lighting devices to allow work to be done. Examples of activities where lights may be necessary are: construction at night, working in a field, playing games at night on an unlighted field, and so forth. Fixed lighting is not located everywhere and alternatives for portable lighting are required.

Some portable lighting devices are found in the market. Such lighting units vary in size. They can range from the small scale battery operated devices that are hand operated and hand carried. These may be found in garages and yards of typical suburban homes. Often these are plugged into an outlet on the wall or use replaceable batteries. Although useful, these portable lights are very limited in their range and cannot provide sufficient light for activities covering a wide area.

In an effort to provide more light, larger scale portable light assemblies were developed. These include having bigger lights which results in a need to have more energy to run. In large scale applications, a common lighting device is a trailer mounted unit that is pulled behind a vehicle. The lights are typically conventional incandescent lights which needed a lot of energy and produced a considerable amount of heat. Power is typically provided through the use of a generator also coupled to the trailer. Although it may appear convenient, standalone trailer units have led to many disadvantages. Often the durability of these units is less than desired. The ride of a trailer is rough and bouncy. More maintenance is required for both the trailer and the generator. Furthermore, bulbs tend to break during transport from the rough rides. Additionally, state registration of the trailer is required. When left alone, theft of the trailers can become an issue.

Although great strides have been made with respect to the problem of portable lighting assemblies, considerable shortcomings remain. A new type of portable lighting assembly is needed that reduces costs and lasts longer. Furthermore, the new lighting assembly is needed that avoids the harsh environment from being pulled in a trailer.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIGS. 1 is a side view of a portable lighting assembly according to an embodiment of the present application;

FIG. 2 is a rear view of the portable lighting assembly of FIG. 1; and

FIG. 3 is a side view of the portable light assembly of FIG. 1 fully extended.

FIG. 4 is a schematic of the portable lighting assembly of FIGS. 1-3.

While the application is susceptible to various modifications and alternative forms, specific embodiments thereof have been shown by way of example in the drawings and are herein described in detail. It should be understood, however, that the description herein of specific embodiments is not intended to limit the application to the particular forms disclosed, but on the contrary, the intention is to cover all modifications, equivalents, and alternatives falling within the spirit and scope of the application as described herein.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The assembly in accordance with the present application overcomes one or more of the above-discussed problems commonly associated with conventional portable lighting assemblies. Specifically, the assembly of the present application is configured to provide a lighting assembly carried by a vehicle in order to lessen harsh forces experienced through riding on a trailer. The lighting system is configured to expand and collapse in order to adjust the height of the lights. Power is optionally provided through the vehicle wiring and power system by coupling to existing trailer plugs associated on the vehicle. This allows the lights to operate without concern for remote generators, thereby minimizing extra weight and equipment. Costs are minimized by removing the need for a generator. These and other unique features of the device are discussed below and illustrated in the accompanying drawings.

The assembly will be understood, both as to its structure and operation, from the accompanying drawings, taken in conjunction with the accompanying description. It should be understood that various components, parts, and features of the device may be combined together and/or interchanged with one another, all of which are within the scope of the present application, even though not all variations and particular embodiments are shown in the drawings. It should also be understood that the mixing and matching of features, elements, and/or functions is expressly contemplated herein so that one of ordinary skill in the art would appreciate from this disclosure that the features, elements, and/or functions of one embodiment may be incorporated into another embodiment as appropriate, unless otherwise described.

The portable light assembly of the present application includes a mount, an extension device, and a lighting unit. The mount is coupled to a hitch on a vehicle and is configured to support the electrical components and associated wiring within the assembly. The extension device is configured to selectively couple to the mount and selectively elevate and lower the lighting unit. The lighting unit is coupled to a portion of the extension device. The lighting unit is configured to electrically communicate with a power source to provide electrical energy to power the lighting unit. Directional orientation of the lighting unit may also be provided to provide light to a particular area.

Referring now to the figures wherein like reference characters identify corresponding or similar elements in form and function. The following Figures describe portable lighting assembly 101 and its associated features.

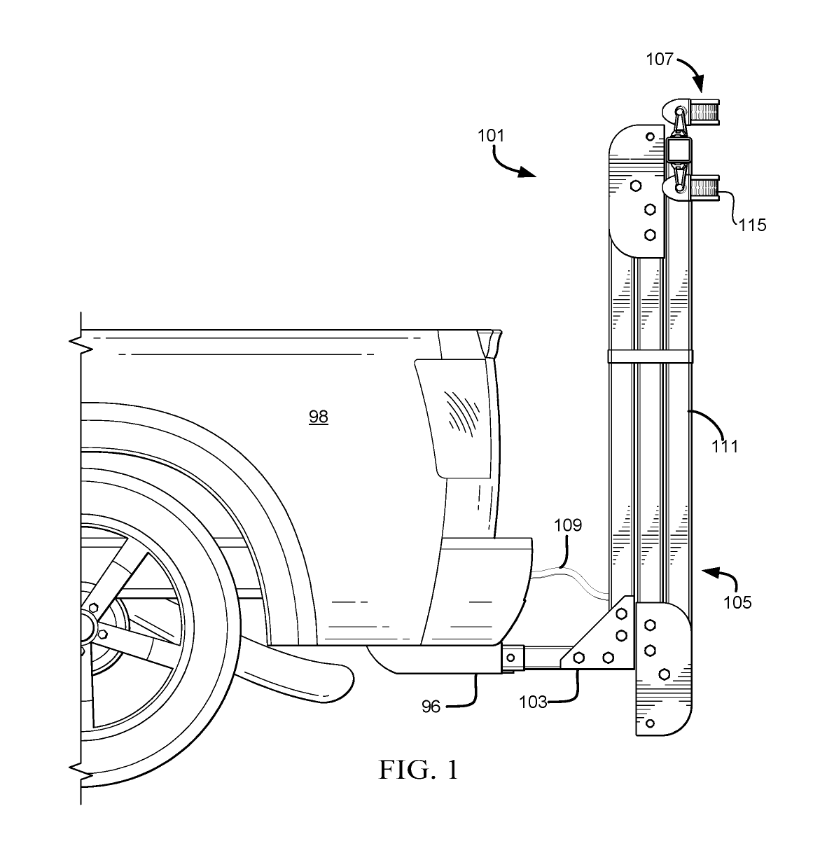

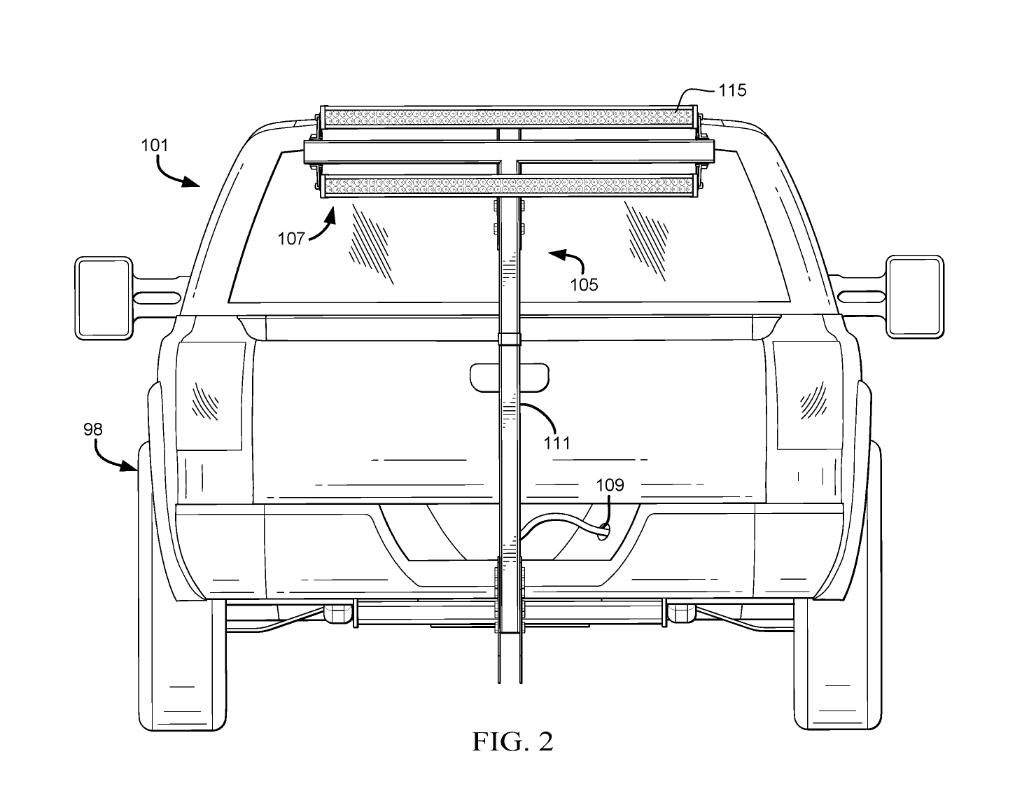

Referring to FIGS. 1-4 in the drawings, various views of portable light assembly 101 are illustrated. Assembly 101 is configured to communicate with a hitch 96 of a vehicle 98. Assembly 101 is transported with vehicle 98. The act of carrying assembly 101 as opposed to pulling it behind vehicle 98 in a trailer lessens the environmental forces experienced during transportation, as vehicle 98 is typically equipped with better suspension. Assembly 101 includes a mount 103, an extension device 105 and a lighting unit 107. Mount 103 is configured to support device 105 and lighting unit 107 by coupling to hitch 96. Device 105 extends off mount 103 and selectively locates lighting unit 107. Assembly 101 is configured to be transported off the ground by vehicle 98 without the use of a trailer. The ride quality of vehicle 98 is vastly better than that of a trailer and therefore lessen premature breakage of bulbs associated with lighting unit 107.

Mount 103 is configured to engage vehicle 98 and support device 105 and lighting unit 107. Mount 103 is designed in a similar fashion to that of conventional receiver devices used to couple to the hitch. Although many different types and methods of attachment to vehicle 98 are possible, a predominantly acceptable method is for mount 103 to engage hitch 96. Mount 103 is designed to slide into the hitch and become secured. Pin connections are used for safety and other traditional and conventional methods of securing the receiver end of mount 103 are used. Chains are not necessary since assembly 101 is carried as opposed to being pulled. The opposing end of mount 103 is designed to support the weight and operation of device 105. Mount 103 extends a selected distance away from vehicle 98 to ensure that operation of device 105 does not accidentally damage or contact vehicle 98. Mount 103 may be configured to allow a user to selectively adjust the distance between device 105 and vehicle 98. This could be done through the use of multiple pin holes or a form of telescoping sleeves. Other methods are contemplated herein.

In order to power lighting unit 107, mount 103 further includes a connector 109. Connector 109 extends between lighting unit 107 and vehicle 98. Connector 109 is sized and shaped in one or more conventional manners to fit conventional vehicle electrical connectors 113 adjacent to the hitch that are used for the operation of trailers. In this way, unit 107 may receive electrical power through the vehicle's existing electrical system. Power may be supplied through the battery, for example if the vehicle is not running. Alternatively, power may be supplied by the alternator when the vehicle is running.

By connecting connector 109 to the existing wiring of vehicle 98, lighting unit 107 is designed to run without the need for a generator. Weight is thereby reduced. Maintenance is reduced. Extra fuel costs are eliminated. A switch may be included to manually regulate the drain of power from the vehicle electrical system. A control module is also included with assembly 101 to allow the user to operate at least lighting unit 107.

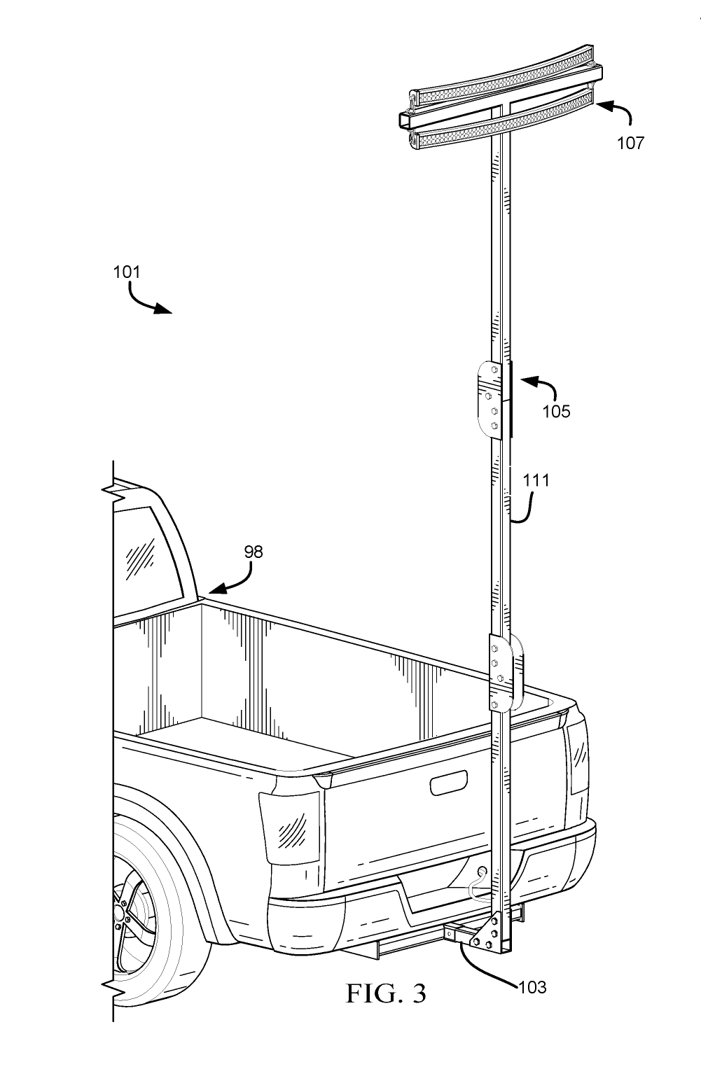

Extension device 105 is secured to an end of mount 103 distal from vehicle 98. As mentioned, device 105 is configured to allow the user to selectively elevate lighting unit to one or more varied heights. The elevation and lowering of lighting unit 107 may be done in many different manners. It is understood that such methods may be automated, powered, or manually operated. FIGS. 1-3 illustrate a manual assembly where device 105 includes a plurality of hingedly coupled arms 111 that are designed to pivot about their ends relative to one another. FIG. 3 illustrates a side view of assembly 101 wherein the arms 111 are fully extended relative to one another. One or more arms may be extended to allow intermediate heights for lighting unit 107. The use of arms 111 allows an additional advantage over telescoping methods, such that the arms 111 may be arranged in non-parallel orientations to each other thereby cantilevering lighting unit 107 away from vehicle 98. Any portion of device 105 may pivot relative to mount 103. Other embodiments may use telescoping methods.

Lighting unit 107 remains coupled to device 105 during times of height adjustment and operation. Lighting unit 107 includes one or more lights 115. The lights may be any conventional type, including: halogen, incandescent, CFL, and others to name a few. Ideally, lights requiring minimal power to operate are preferred. Each light is in electrical communication with a power supply 117. Power supply 117 is configured to provide electrical energy to unit 107. Power supply 117 may be a generator or any other portable or removable source of stored energy from vehicle 98. In the present application, power supply 117 is the electrical system of vehicle 98 itself. Lighting unit 107 is configured to permit the selective adjustment or orientation of lights 115 relative to device 105. Lighting unit 107 may include any number of pivoting apparatuses, swivels, or tilting mechanisms to orient the lights.

It is desired that the construction of light assembly 101 is done with light weight and strong materials to permit a single user to lift it and insert it into the hitch. Mount 103 is able to be sized to fit a particular hitch size (Class I, Class II, Class III, Class IV, etc . . . ). An adapter may also be included within system 101 to allow system 101 to be swapped between different sized hitches.

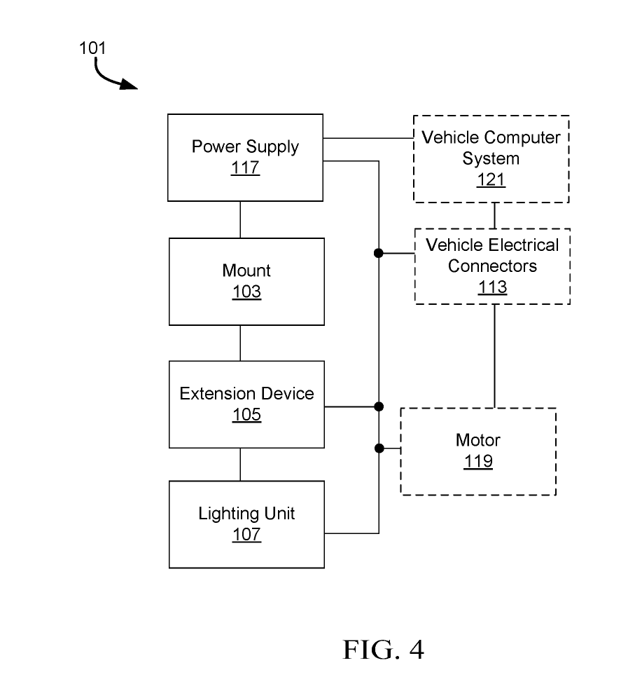

Referring in particular to FIG. 4 in the drawings, a schematic of assembly 101 is illustrated. The same components previously described are illustrated. Additionally, a motor 119 may also be included in assembly 101. Motor 119 is configured to permit powered operation of at least one of the extension device 105 and the lighting unit 107. This allows for the electrically operated functions of assembly 101 as opposed to manually operated methods. Additionally, assembly 101 may further be configured to sync or communicate with the existing vehicle computer system 121 of vehicle 98. System 121 would operate through electrical interfaces in the cab of vehicle 98 and provide a user the ability to regulate all the functions of assembly 101 while staying in the cab.

In operation, system 101 is lifted and inserted into the hitch on vehicle 98. The use of the adapter is optional. System 101 is secured as necessary. Vehicle 98 is then driven to a desired location, being carried by the hitch on the vehicle. Lighting unit 107 is elevated to the necessary height and the lights are operated as needed. Lights may be turned on during driving. Another feature of system 101 is the ability for the operative control of assembly 101 through system 121 while remaining internally within vehicle 98. A driver is capable of arriving at a site and while driving or parked, operate and orient the various components of assembly 101 so as to shine light to a defined area.

Assembly 101 includes a number of advantages, such as at least the following: 1) minimized vibration during travel due to increased ride quality of the vehicle; 2) lower repair costs; 3) decreased maintenance; 4) longer operational time; 5) optional control within the cab of the vehicle to adjust lights, power lights, and/or operate the extension device from inside the vehicle and even while driving; and 6) powered through the trailer pin connectors associated with the hitch. Other features exist and are clear from the description of assembly 101.

It is evident by the foregoing description that the subject application has other significant benefits and advantages. The present system is amenable to various changes and modifications without departing from the spirit thereof. The particular embodiments disclosed above are illustrative only, as the apparatus may be modified and practiced in different but equivalent manners apparent to those skilled in the art having the benefit of the teachings herein. It is therefore evident any alterations, modifications, and all such variations are considered within the scope and spirit of the application. It is apparent that an apparatus with significant advantages has been described and illustrated.

What is claimed is:

1. A portable light assembly for a vehicle, comprising:
a mount configured to engage the vehicle;
a lighting unit configured to illuminate a defined area; and
an extension device in communication with the mount and configured to elevate and orient the lighting unit.

2. The assembly of claim 1, wherein the mount elevates the lighting unit off the ground.

3. The assembly of claim 1, wherein the mount couples to a hitch on the vehicle.

4. The assembly of claim 1, wherein the extension device is configured to extend to a plurality of varied lengths so as to selectively elevate the lighting unit.

5. The assembly of claim 1, wherein the extension device is pivotally coupled to the mount.

6. The assembly of claim 1, further comprising:
a power supply configured to provide electrical energy to the lighting unit.

7. The assembly of claim 6, wherein the power supply is the electrical system of the vehicle.

8. The assembly of claim 1, further comprising:
a motor in communication with a power supply, the motor configured to permit powered operation of at least one of the extension device and the lighting unit.

9. The assembly of claim 6, wherein power is provided through existing electrical connectors on the vehicle.

10. The assembly of claim 6, wherein the power supply is removable from the vehicle.

11. The assembly of claim 1, further comprising:
a vehicle computer system to permit control of at least one of the extension device and the lighting unit from within the vehicle, the vehicle computer system configured to share electrical energy with the lighting unit.

12. The assembly of claim 1, wherein operation of the lighting unit is controlled via a vehicle computer system.

13. The assembly of claim 1, wherein operation of the extension unit is controlled via a vehicle computer system.

14. A method of providing light to a predefined area, comprising:
providing the assembly of claim 1;
inserting the mount into a vehicle hitch; and
providing electrical energy to the lighting unit.

15. The method of claim 14, further comprising:
elevating the lighting unit via the extension device.

16. The method of claim 14, wherein the act of operating the extension device is performed manually.

17. The method of claim 14, wherein the act of operating the extension device is performed electronically.

18. The method of claim 14, further comprising:
coupling the lighting unit to the vehicle electrical connectors to receive power.

19. The method of claim 14, further comprising:
regulating the operation of at least one of the extension device and the lighting unit through the vehicle computer system.
